(19) United States
(12) Patent Application Publication
(10) Pub. No.: US 2004/0239624 A1
(43) Pub. Date: Dec. 2, 2004

(54) Freehand symbolic input apparatus and method

(76) Inventor: Artoun Ramian, Madrid (ES)

Correspondence Address: Law Office of William B. Ritchie, 43 Jackson Street, Concord, NH, 03301, US

(21) Appl. No.: 10/817,150

(22) Filed: Apr. 2, 2004

Related U.S. Application Data
(60) Provisional application No. 60/459,771, filed on Apr. 2, 2003.

(51) Int. Cl. G09G 5/00

(52) U.S. Cl. 345/156

(57) ABSTRACT

An input apparatus that can be customized and utilized by users having a wide range of physical abilities. The Input apparatus can be used to act as the input interface for other devices. The invention can be incorporated into virtually any device controlled by user commands and other forms of data entry. The simplest embodiment of the invention is conceptually similar to the keypad of a mobile phone. Inputs are made through the input surface, which is a collection of sparsely placed pressure, or touch sensitive, sensors which track the movement of the implement (user's finger or stylus). The implement is brought into contact with the input surface and is moved across the input surface, visiting various preset points, optionally guided through channels in the input surface, along approximate straight or curved lines or paths. The series of lines, formed by the interconnection of the preset points forms a trace path. The trace path is stored in a database, through a training phase, wherein the user can “teach” the invention his/her preferred valid inputs and associated symbols. The term “symbol” is defined as any character or other recognized glyph, known to the user, or to the corresponding device. When a valid input has been linked to a symbol, this is known as an association. Associations are controlled by the user and need have no logical meaning. The invention requires multiple sensors, at least one processor (CPU), at least one power supply which may be provided by the corresponding device, at least one static memory module for storing the corresponding database and software and at least one implement and at least one output port through which information is emitted to the corresponding device.

This application claims benefit of U.S. Provisional Application Ser. No. 60/459,771, filed Apr. 2, 2003, pursuant to 35 USC §119(e).

### BACKGROUND OF INVENTION

1. Field of the Invention

The invention generally relates to electronic input apparatus, specifically user controlled devices such as trainable input devices akin to graphics tablets, stylus input and touch screens.

2. Description of the Related Art

In the field of input devices, many attempts have been made to create a device which can be utilized by users having different levels of physical ability, technological experience, and in different languages. For example, numeric keypads, which have digits zero through nine, typically have a consistent layout, whether they are applied to television remote controls, mobile telephones or fixed line telephones.

When taking into consideration other devices, such as palm-top computers, personal stereos, microwave ovens, etc, the user interfaces, i.e. layout of the digits and other functions assigned to the digit buttons, differ dramatically. This frequently leads to confusion among users.

With input devices that utilize a stylus, such as that found coupled with handheld pocket computers manufactured by PALM PILOT, the user is required to trace out a preset pattern for each character available for input. If the user incorrectly traces out the pattern of a letter then either the input is not recognized or an incorrect letter will be input.

The user is not able to train such an input method as to the user's preferred manner of writing each character or symbol. Further, in order to remember how each character or symbol ought to be traced out, reference needs to be made to a chart, which indicates how the symbols are represented by strokes of the input stylus.

Hand held, and desktop systems alike offer a screen based keyboard which the user can either tap, to select characters, with a stylus, or click on letters with a mouse. This feature is usually described as an accessibility feature. The drawback is clearly that the keyboard takes up a great deal of the available screen space, limiting the screen space available to any software application which is linked to the screen based keyboard.

In those cases where a compact, small sized, device is used to provide input such as a touch pad; the push button input interface is usually withdrawn.

A prior art universal remote control has the ability of displaying symbols to represent various functions, with the symbols taking the form of icons. This type of universal remote control requires a connection to some kind of computer system, from which templates of icons and groups of functions can be downloaded. Therefore, the universal remote control is not a stand alone, self contained, input device, since the user interface of the remote control is programmed by external devices.

Therefore, having a substantially universal, standalone and trainable, input device, driven by the motion and pressure of a finger or stylus, which can be used in conjunction with numerous other devices, such as personal entertainment devices, all manner of telephones, remote controls and the like is not found in the prior art.

### SUMMARY OF THE INVENTION

The invention is an input apparatus that can be customized and utilized by users having a wide range of physical abilities. Input apparatus can be used to act as the input interface for other devices.

It is another aspect of the input apparatus to respond to pressure from the user's finger or to respond to pressure from a stylus or similar object.

It is another aspect of the input apparatus to respond to gentle, almost zero pressure, from the user's finger or input stylus and the like.

It is yet another aspect of the input apparatus to optionally provide a series of interconnected channels, by which, a finger or stylus, or similar apparatus, can be guided along sensors forming an input surface.

It is another aspect of the input apparatus to utilize various sensors to sense movement of an implement upon an input surface.

It is another aspect of the input apparatus to reduce the randomness of input from infinite trace paths to a calculable finite set of trace paths, where trace paths means routes which can be taken by the user's finger or input stylus and the like, while traveling over the input surface.

It is another aspect of the input apparatus to store trace paths, utilized by the user, in a corresponding database.

It is another aspect of the input apparatus to at least partially illuminate the most recent trace path in order to indicate that path traced upon the input surface.

It is another aspect of the input apparatus to recall and at least partially illuminate any previously traced path in order to demonstrate path associated with a selected symbol, which has been stored in a corresponding database.

It is another aspect of the input apparatus to act as a method of input for text characters of any language, numerical characters, mathematical symbols, or any other well known symbol or a symbol known to the user.

It is another aspect of the input apparatus to allow the user to associate any currently or previously traced path with at least one system command, which is emitted to and known by a corresponding device that receives input from the input apparatus.

It is another aspect of the input apparatus to allow the user to associate any currently or previously traced path with at least one symbol, which is emitted to and known by a corresponding device that receives input from the input apparatus.

It is another aspect of the input apparatus to allow the user to trace a path which can be used as a password that may be issued to activate a corresponding device which receives input from the input apparatus.

It is the final aspect of the input apparatus to allow the user to trace a path which can be used as a digital signature, known only to the user, and disclosed only upon the user's command.

The invention is an input apparatus which collects patterns of movement from the user, created by movement of a finger, stylus or similar device. The patterns of movement are known as traces or trace paths.

Individual traces are each related to a specific action, which is determined by the user, though a set of default actions is contained within a corresponding database.

If the invention were linked to a personal computer, one trace might be used to represent a copy action, which places some text on the clipboard, while another trace might be used to execute a paste action of any text on the clipboard into the same or a different document.

If the invention were linked to a corresponding mobile telephone, numerous traces would be used to represent the digits zero through nine, while other traces would represent commands for answering and disconnecting calls.

The action assigned to any trace is determined by the user at any time after the trace itself has been recorded.

While a trace is being recorded for the first time, the user can optionally have the invention illuminate the path which was used to form the trace on the input surface.

Illumination is optional, as for power-saving reasons, the input apparatus may be required to consume as little energy as possible. Additionally, the corresponding device, to which the input apparatus is connected, may have its own method of displaying trace paths, for example, by a method of using a Liquid Crystal Display (LCD).

The “switched” embodiment of the input apparatus forms an input surface from a series of interconnected sensors, such as micro-switches, which is totally unlike a traditional rectangular graphics tablet or touchpad. In this embodiment, the invention uses a network of switches, the switches representing individual points, which are sparsely placed on a surface of the corresponding device, in order to allow the user to form lines, where line is defined as a connection between at least two points, and further, where a collection of at least one point forms a trace.

The “tablet” embodiment of the input apparatus forms an input surface from a touchpad, such as that found on personal computer keyboards and laptops. In this embodiment, points are formed by known X/Y locations on the touchpad surface, and lines are formed by the user visiting a sequence of known X/Y locations, in order to form the lines, which in turn forms a trace.

Corresponding device is defined as any device which is connected in accordance with the invention for the purposes of receiving, as input, any and all information emitted by the invention, while simultaneously being able to provide information to the invention, which can be displayed by illumination of parts of the input surface of the invention.

If the corresponding device is a mobile phone, then input apparatus must be incorporated into an appropriate surface, such as in and around the traditional keypad area. In this way, the input surface is closely integrated with the input area of the mobile phone which is the keypad of the mobile phone. Therefore, the invention does not significantly increase the size of any corresponding device connected to it.

In the “switched” embodiment, coupled with a corresponding mobile phone, micro-switches are interspersed among the normal keys of the mobile phone keypad. The micro-switches and keypad keys lay virtually flat on a surface, such that, as a stylus or finger moves over the surface the micro-switches would present least physical resistance, and would therefore be depressed, in preference over the keypad keys. More clearly put, a light touch will be sufficient to depress the micro-switches whereas a more deliberate effort should be made to depress the keypad keys of the mobile phone itself.

In the tablet embodiment, coupled with a corresponding mobile phone, a touchpad is utilized which contains, flat in its surface, the keys of the mobile phone keypad. Again, the lightest touch activates the touchpad as an input sensor, whereas, heavier physical pressure is required to press the keys of the keypad itself.

The user activates the invention by applying pressure to a series of preset points, in order to form a series of interconnected lines, beginning and ending at each of the preset points. The series of interconnected lines forms a single trace, which is associated with an action, character or symbol.

For example, with the mobile phone illustration above, a series of traces representing a telephone number, “555 666 777”, causes the invention to capture the trace of each digit. The actual interpreted digits are emitted to the mobile phone, not the trace paths. The mobile phone behaves as though the user had dialed the digits in from the traditional keypad.

Similarly, if the user were to write “diary”, or “address book”, on the invention's input surface, the mobile phone would immediately present the user with its diary or address book facilities, rather than the user having to navigate a sequence of complex menus. This feature significantly flattens the hierarchy of mobile telephone menus, effectively making each feature of the mobile phone available at a “single-click” as oppose to “many clicks”.

The user is not required to associate traditionally shaped traces with characters which are emitted to a corresponding device. For example, the user can associate a trace similar to the letter “O”, yet have this interpreted as the character “A”, and have the “A” character sent to the corresponding device. This example highlights the fact that any continuous trace path can be associated with any character or symbol known to the user, which can be represented by the traces.

If the user utilizes their finger, then as the finger moves over the input surface, the interconnected lines, which form the trace, illuminate, therefore, the user can see previous lines of the path of the trace as new lines are being added.

In order to remind the user how any trace was formed, the invention provides a facility for recalling a trace associated with any character or symbol. This avoids the need for the user to make reference to any chart or index of traces.

The invention can optionally utilize automatic early completion of a trace. As an input trace, which is defined as the current collection of lines being created by the user, is being input, the system searches the corresponding database to find any partially matching stored traces. If the count of partially matching stored traces equals one, then the single partially matching stored trace can be accepted automatically, without the user having to complete the full trace.

The invention also allows the user to associate a trace with multiple characters, symbols and commands.

When a number of traces are being used to form a word, character by character, the invention provides automatic word completion.

It is preferred that a series of channels, or grooves, down which the finger or stylus are guided while traces are being formed on the input surface are incorporated. This is not required to make the input apparatus function, but it greatly assists the user in moving swiftly between points to form lines and traces.

Due to the fact that the input surface can illuminate display characters or symbols, it can also be used by the corresponding device or the invention to output information, such as indication of state, presentation of graphics or text to the user.

Devices exist that can record changes in pressure and speed of movement when monitoring the movement of a finger, stylus, or the like, across the input surface.

By incorporating the aspects of information related to speed and pressure, the input surface is able to effectively record the behavior of the user while creating traces on the input surface. This type of information capture is more commonly referred to as biometric data capture.

In the prior art, biometric data capture is taken as a method of user identification, wherein, a first dataset, initially created by a first user, is stored in a biometric database. At a later time, the first user, or a second user, creates a second dataset. If the first and second datasets are substantially identical, then it is said that the first user has correctly been identified. If the first and second datasets are dissimilar, then either the first user has incorrectly attempted to recreate the first dataset or a second user has attempted to forge the first data set unsuccessfully. Typically, the first and second datasets represent a voice recording, fingerprint or signature, captured by a biometric input device which is well known in the art.

By using biometric data, the invention provides a method of constantly “fingerprint checking” the user. Thus, every trace is entered on the input surface. The invention is constantly ensuring that the user, who created the trace in the first instance, is the same user who is, at the present time, recreating the same trace. The invention substantially outperforms devices which simply allow operation of the devices after initial checking of a single password. Rather, every trace becomes a password, as no two users are likely to enter the same trace path, with the same speed and same pressure.

The use of biometric data by the invention to validate input of characters, symbols and the like is referred to as trace-check.

Trace-check is an optional feature of the invention as additional processing power is required, and the amount of information recovered from the corresponding database increases accordingly. Therefore, when constructing simpler embodiments of the invention, the use of trace-check could be omitted.

Trace-check can be implemented in a range or time span sense. The trace-check can be employed, for example, in the early stages of a document being created. Then, as time passes, trace-check is used less and less. It in a sense relaxes. Thus, it becomes more confident that one specific user is and will continue to use the input apparatus in the current session. This method of applying trace-check can significantly reduce computational effort which, in turn, with modern computing devices may reduce power and other resource consumption.

Looking at ranged trace-check another way, the level of confidence is low when the user first starts to create a document but rises rapidly as more and more characters, or traces, are entered. Therefore, if there is a chance that a user may be misidentified at the beginning of document creation, by the end, the chances of such an error are massively reduced. Therefore, a method of proof of authorship is thus disclosed, wherein the confidence level of having a correctly identified user is extremely high. Effectively, the invention is continuously password checking the user with every character entered. Whereas, the prior art typically does a one-time only password check, typically right before work begins such that the user is given typically unlimited access to information.

Devices also exist in the art which are capable of providing tactile feedback in the form of pressure resistance or vibration. For example, a sensor on the input area can be made to vibrate when illuminated. The sensation could be used to detect through touch for the visually impaired in order to “read” what was displayed on the input surface. Pressure resistance is a method of making an object, which would normally move when pressure is applied, less able to move. In other words, the user senses resistance to the applied pressure. This again is a form of tactile feedback available to visually impaired users.

Through use of input sensors, light emitting components, and tactile feedback components, the input surface can remain consistent across applications, increasing user familiarity and shortening the learning curve of any new equipment.

Other aspects, features and advantages of the invention will become obvious from the following detailed description that is given for the embodiments of the invention, while referring to the accompanying drawings.

### BRIEF DESCRIPTION OF THE DRAWINGS

FIG. 1 is an illustration of the components of the input/output surface of the invention.

FIG. 2 is an illustration of tracing example characters and symbols on the input surface.

### DETAILED DESCRIPTION OF THE INVENTION

The invention is an input apparatus and method which can be incorporated into virtually any device controlled by user commands and other forms of data entry. The simplest embodiment of the invention is conceptually similar to the keypad of a mobile phone, as both the invention and the keypad of the mobile phone allow calls to be dialed, terminated and managed by various features of the mobile phone itself.

Inputs are made into the invention through the input surface, which is a collection of sparsely placed pressure, or touch sensitive, sensors which track the movement of the user's finger, input stylus, or the like. These are all referred to as the implement which comes into contact with the input surface.

The implement is brought into initial contact with the input surface by the user, and the implement is then moved across the input surface, visiting various preset points, optionally guided through channels in the input surface, along approximate straight lines or curved paths.

The invention forms lines between the preset points, as the implement travels across the input surface, with the lines being indicated by illuminated segments contained within the input surface.

The series of lines, formed by the interconnection of the preset points forms a trace, a single line, potentially with a long and convoluted shape, or having few segments, but overall, appearing to be angular and continuous.

If a trace is made up of interrupted, that is, disconnected lines, then it is referred to as a discontinuous trace. For example, the “i” character would be referred to as a discontinuous trace as it is made of a vertical line, capped by a single dot, neither being physically connected to the other.

Both a trace and discontinuous trace are referred to as valid inputs, captured by the input surface.

A valid input is first recorded and stored in a database, through a training phase, wherein the user can “teach” the invention their preferred valid inputs and their associated symbols.

The term “symbol” is defined as any character or other recognized glyph, known to the user, or to the corresponding device.

When a valid input has been linked to a symbol, this is known as an association.

Associations are controlled by the user and need have no logical meaning. For example, a trace, being a single straight line can be linked to the character “A”. Thereafter, whenever the user draws a straight line of any length, the invention outputs a character “A” to the corresponding device.”

To further exemplify the diverse nature of associations, the user could write the text “Pi” on the input surface, and have the appropriate mathematical symbol output to the corresponding device.

Associations, can more specifically be defined as one trace linked to at least one symbol. That is, the input of one trace can result in the output of one or many symbols.

Any input which can be executed by the user through writing, push buttons and the like, upon the user interface of the corresponding device, can similarly be produced through use of the input surface of the present invention.

The invention provides illuminated segments in the input surface to provide an indication of what interconnections upon the input surface are in use to form a current trace, or, were used to form a previously stored trace.

In order to construct the invention and monitor the formation of traces and associations and output symbols to the corresponding device, the invention requires the inclusion of multiple sensors, at least one processor (CPU), at least one power supply which may be provided by the corresponding device, at least one static memory module for storing the corresponding database and software required by the invention, multiple illuminated segments for outputting traces, at least one implement and at least one output port through which information is emitted to the corresponding device.

Some optional components of the invention include channels in the input surface, which guide the implement, tactile feedback devices and audible feedback devices.

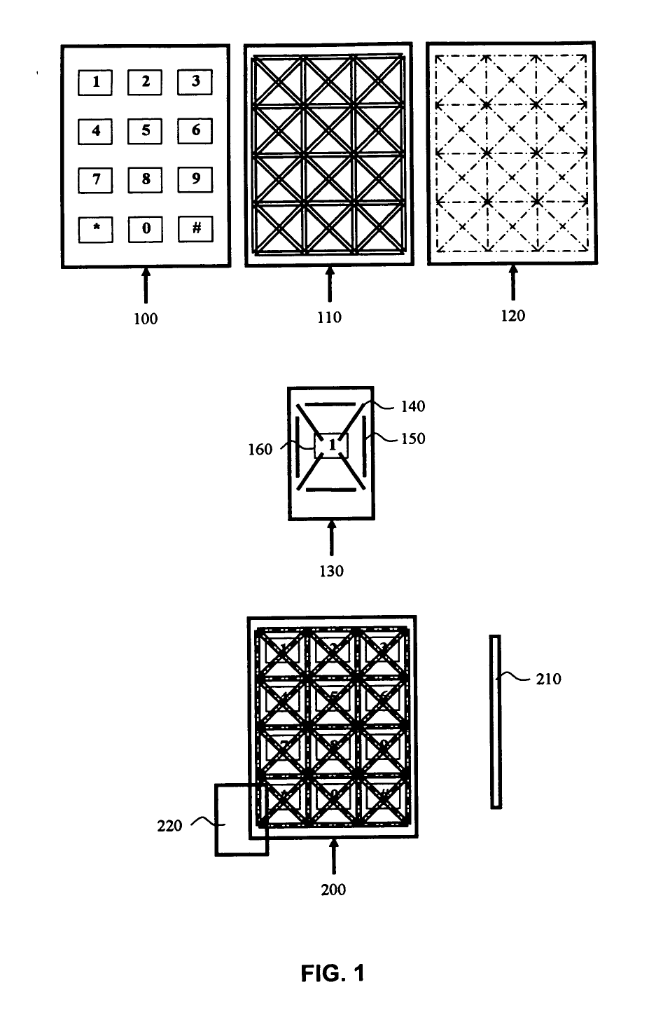

Referring then to FIG. 1, a view of the components required to form the input surface is shown. Keypad 100 illustrates the typical layout of a mobile telephone keypad. This is similar to the layout of the number keys on a remote control unit with the exception that a mobile phone keypad requires the additional “*” and “#” character.

Sensors 110 are a collection of any device capable of sensing pressure in a reasonably precise fashion in a confined area. Push-buttons can form sensors 110, provided the push-buttons are the type which can be depressed with very little pressure.

Light Emitting Device (LED) 120 is a collection of segmented illuminating sections which have an on or off state. Each segment in LED 120 can be provided by any well known electroluminescent material, which glows when a voltage is applied. Such electroluminescent materials can be screen printed, so the volume added to the size of the corresponding device is negligible.

Input surface (ISF) 200 shows keypad 100, sensors 110 and LED 120 all superimposed and assembled together, in order to form the input surface of the invention.

ISF 200, therefore, has the ability to detect push button inputs from the digits 0 to 9 and “*”, and “#” characters, with the further ability to sense movement of implement 210 across sensors 110.

Implement 210 can be provided by the user's finger, or preferably an input stylus, being a pen-like plastic object.

Parts explosion 130 shows an illustrative zoomed view of an area of ISF 200 around the digit “1” of keypad 100. This clearly shows the segments of sensors 110 which surround digit “1” of keypad 100. The individual sensors, for example, sensor 140 and sensor 150, further illustrate individual pressure sensitive areas, over which implement 210 can travel and activate. The invention responds to pressure upon areas such as sensor 140 and sensor 150 by building a trace line for the current input, but as will be explained, this occurs under a set of closely defined timing rules.

Sensors 140 and 150 sense motion between two points, which is required to form a line which contributes to the overall path of a trace being drawn by implement 210.

When the sensors are configured as illustrated in zone 130, as implement 210 travels along segment 150, the potential for running over sensor 140 is present. However, by using elongated sensors, as oppose to specific point locations, this potential can be substantially eliminated.

Key 160 is illustrated as the digit 1 on a mobile telephone keypad, around which the sensors are dispersed.

The term “timing rules” is defined to mean a collection of governing chronological criteria which causes the beginning and end of an input sequence, triggered by the use of implement 210.

Timing rules will, for example, allow the user to place implement 210 on ISF 200 and move implement 210 around. This causes pressure to be applied to various sensors within sensors 110. By lifting implement 210 from ISF 200 and replacing it at another point, the invention recognizes this as a single input, as oppose to two distinct inputs.

Sensors 110 can alternatively be enabled by pressure sensitive devices which yield distinct readings for distinct and differing amounts of pressure. In effect, each sensor within sensors 110 behaves like an analog to digital converting device known in the art as a strain gauge. Prior art touchpads on laptop computers are capable of monitoring the amount of pressure applied by a finger, so this requirement can be easily implemented into ISF 200. An alternative way of monitoring pressure is to have a single sensor beneath ISF 200 which monitors the average pressure across the entire surface of ISF 200. That is to say, that no matter where pressure was applied to ISF 200, a single sensor, strategically placed beneath ISF 200 would give a reasonable reading as to the current pressure being applied by implement 210.

Thus, the use of a single pressure sensitive device (PSD) 220 is the simplest configuration to construct. PSD 220 is placed at the corner of ISF 200, as downward pressure in any area will result in a strain being placed on PSD 220, which is monitored by the invention.

PSD 220 is one method of allowing the invention to have knowledge of when implement 210 is in contact with ISF 200. ISF 200, when formed by use of a touchpad will automatically inform the invention of when implement 210 is in contact with it, as well as often being able to report the amount of pressure being applied. For example, a SYNAPTICS touchpad will report the fact that there is contact with a finger, as well as the amount of pressure being applied, within a recognizable range. Therefore, the inclusion of PSD 220 will only be required if a component of ISF 200 does not in itself have the ability to report pressure readings. Pressure readings are only required, however, if biometric data is to be captured during input of trace information.

Biometric data, defined as information which is collected in order to identify the behavior of a user, is collected by pressure monitoring and velocity measuring.

When implement 210 is moved by a user in a specific pattern of movements, over and over again, it is likely that the same pressure and same velocity could be observed virtually every time. For example, if the user was to trace the character “S” on ISF 200, the amount of pressure during the trace and the speed at which the “S” was drawn would likely be the substantially the same every time the “S” was drawn by the user.

If a second user were similarly to draw the “S”, it is highly probably, in fact, virtually guaranteed, that the second user would draw the “S” with different pressure and velocity to that occurring from the first user.

The art of monitoring the first user and second user behaviors is well known in the current art, and it is a well accepted practice to allow identification of a user by the uniqueness of the path, velocity and pressure occurring when a signature, or in fact, any trace path upon a surface is recorded.

It is an option to facilitate for the integration of biometric monitoring of inputs occurring on ISF 200. If a first user were to write the text “ONCE UPON A TIME” on ISF 200, and were then to put the invention down, such that a second user could pickup the invention and continue writing, “INA LAND FAR AWAY”, the invention would “know” that a second user were writing, and could optionally allow or disallow the input, or even accept it so the user could review what had been written and choose to accept or discard all input by the second user. The invention is an ideal workgroup input device, which can be passed among a number of users.

A further example, word-processors are known to be able to annotate a document, where multiple users each using their own individual computers, can annotate the same document. The fact that a different user is logged on to each computer allows each of the computers to know its user, and can mark annotations as being made by each individual user, actually adding the initials of each user, to each of their annotations, such that all users reading the document at a later time will know the owner of each annotation. In a workgroup situation, this basic feature is essential to tracking and tracing inputs, especially during brainstorming sessions.

The use of biometric monitoring as an optional feature within the invention can be invaluable in some situations. In the field of security applications, biometric monitoring is almost a prerequisite in the modern day. In fact, one bank in the United Kingdom has begun a full scale implementation of biometric signature recognition devices, used by its customers to authenticate their identities.

The invention offers the same level of assurance of identity but vastly reduces the random nature of inputs on a graphics table style input surface.

For example, on a graphics tablet, as an example, it is possible to have one hundred million different traces, or squiggles. With the optional channels on ISF 200 this number might be reduced to mere thousands, or even hundreds. To further exemplify this simplification, with only four push buttons it is possible to verify the identity of a user, simply by asking each to push the four buttons, one time each, at a speed and in a sequence preferred by each user. The chance that any two users will choose the same sequence, in which to push the four buttons, and do so with the same time period between each depression of the four buttons, is infinitesimal.

The biometric abilities of the invention can therefore be seen to range from simple identification of a user prior to login, wherein a user profile is loaded as the logged on user is identified, up to finger printing of individual character inputs to a document.

A more complex embodiment of the invention allows a network of many ISF 200 to be connected to a central hub, such that many users can each use their own single instance of ISF 200, which eliminates the need to pass around a single ISF 200.

The network could feasibly be embedded in a conference room table, where each chair is placed conveniently near an instance of ISF 200 connected within the network. It can readily be seen how the users can interact over the network, authoring a document, or brainstorming an idea displayed on a single screen.

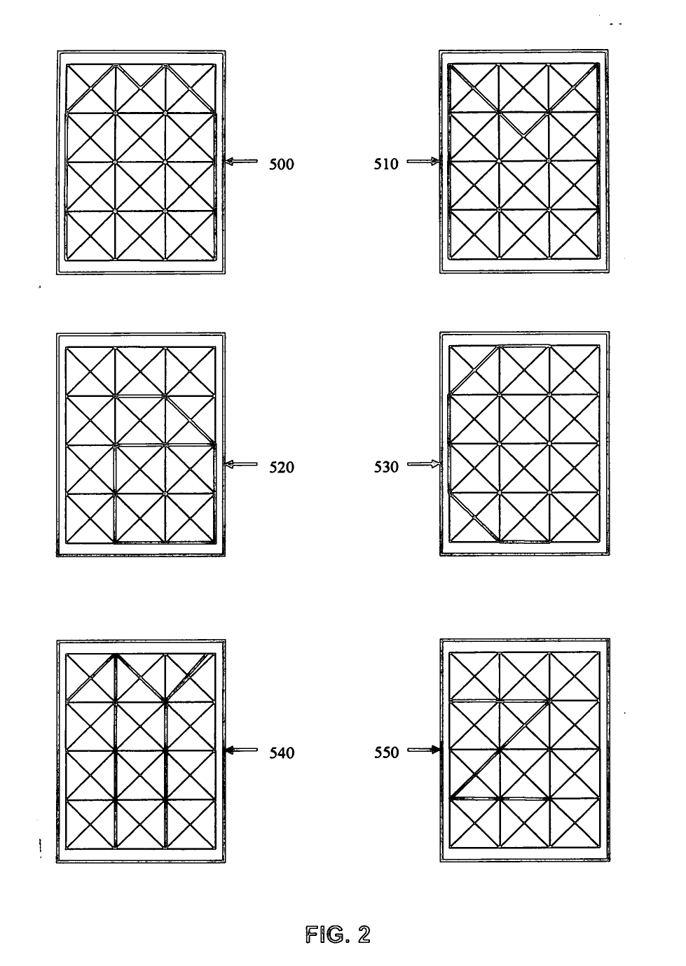

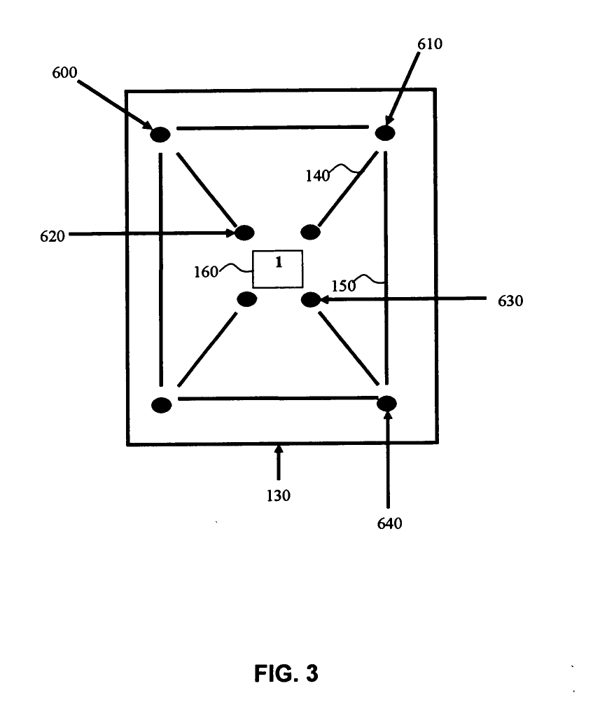

Referring now to FIG. 2, example traces for various symbols are shown. Character “M” 500 and character “M” 510 both represent the same alphabetic character, but each are drawn with a different input trace, i.e. diverse movement of implement 210.

Character “a” 520 shows one input path which would reflect the input trace used by the user to form the alphabetic character “a”. Character “C” 530 shows the same type of example, and so it can be seen that traces can follow upper or lower case letters. The invention is able to differentiate between upper and lower case letters. However, case insensitive input is the preferred standard for input, with the invention automatically applying capitalization as required for proper names, starts of sentences and abbreviations, all of which can be trained by the user.

For example, when the user enters the text, “tla”, the invention can be trained to automatically capitalize the text to “TLA”. This ability is well known and currently in use in word-processing software such as Microsoft's WORD.

The symbol for Pi 540 is illustrated as is a lower case “z” 550.

By looking at characters 520 and 550, the traces are not required to be placed in the centre, or to on side or the other of ISF 200.

It is possible that the user will use ISF 200 while it is rotated 90 degrees to the left or right, in effect using the corresponding device in landscape mode.

This procedure is referred to as normalization. Thus, no matter how a trace occurs, as long as a specific shape results, then it will be recognized. For example, character “z” 550 can be drawn beginning at the top left corner or at the bottom right corner, but both methods would ultimately result in the same shape, or trace, having been drawn.

Normalization is optional within the invention for the following reason. Referring back to keypad 100 (see FIG. 1), if the invention were connected to a system running MICROSOFT WINDOWS, then a trace moving from digit “1” to digit “4” of keypad 100 could cause a window to be minimized, where a movement from digit “4” to digit “1” could be used to maximize a window. With normalization in effect, a movement from digit “1” to digit “4” would ultimately be viewed as the same as a movement from digit “4” to digit “1”. Normalization can be applied on a trace by trace basis. For example, normalization could be applied to all alphabetic characters, but all traces which were trained as commands, for example, the minimize and maximize commands illustrated above, would be exempt from normalization.

A user skilled in the art of shorthand would readily be open to the suggestion that the input of a single trace could result in the output of many characters. For example, drawing the basic shape of a house on ISF 200 could be trained to output the text “HOUSE”, or “HOME”, to the corresponding device.

Similarly, when navigating the World Wide Web, the invention can be used as a pictographic input device, where drawing the same shape of a house could be used to go to the user's home page on the word wide web.

Many other examples of pictographic input of commands for the corresponding device are: drawing a down arrow to scroll down, scratching randomly and quickly on ISF 200 to represent erase, using single up or down strokes to zoom in and out of a picture, using a tick or cross picture to represent OK or CANCEL actions.

Due to illumination from LED 120, it is possible to use the invention in dark environments.

The purpose of LED 120 is to show the user the activated zones in sensors 110, wherein, as each sensor is activated, a corresponding segment in LED 120 lights to show the current trace path. LED 120 can be used as an output device, being illuminated to display characters, symbols and graphical information.

It is not necessary for the optional channels in ISF 200, used to guide implement 220, to be straight lines. Some of the channels could be arcs as would suit the needs of the corresponding device.

A trace begins as soon as implement 210 causes a first sensor in sensors 110 to become activated, optionally followed by more sensors, finally ending when a last sensor. The last sensor can be the same as the first sensor, if no additional sensors are activated. For clarification, a trace must include activation of at least one sensor.

Trace input can also be terminated by the depression of a key in keypad 100. The invention would interpret that a trace had begun as soon as implement 210 comes into contact with ISF 200, but would switch to a traditional input mode as soon as a key in keypad 210 were depressed, thus discarding any trace input up to the point of the depression of the key in keypad 100.

The layout of keypad 100 is exemplary, as keypad 100 would change to suit the needs of the corresponding device. As has been indicated, the need could range from mobile phones to microwave ovens and include the likes of remote controlled entertainment systems, web browsing and computing devices and even surgical equipment.

The fact that the invention can provide tactile feedback, by causing some kind of motor feedback through sensors 110, results in the user being able to use the invention “unsighted”. Therefore, the user need not be looking at the invention in order to use it. In fact, the invention could be placed in a concealed place, which leads to a further embodiment of the invention, which includes the placement of a canopy over ISF 200.

The canopy shields the movements of implement 210, used to input on ISF 200. In other words, if an observer were to try to see the actions of the user while inputting with movement of implement 210, the movements would be hidden by the canopy.

A simple, graphics tablet embodiment (GTE) of the invention could also be formed from a traditional graphics tablet, or computer touchpad, of the kind used on laptop computers, wherein channels in the graphics tablet would render it similar, in mechanical nature, to sensors 110. In the GTE embodiment, LED 120 would not be required, nor would keypad 100.

Yet another embodiment, zero-illumination embodiment (ZIE) would omit the use of LED 120. Instead, ZIE would utilize a screen or display included in the corresponding device to illustrate trace paths.

The aforementioned training phase is optional if the user wishes to have the invention respond to traces which may be considered non-standard, or traces which result in the output of two or more symbols.

For example, the corresponding database, containing associations, can be supplied to a user with a default set of data. This means, off the shelf, the invention would be able to recognize all symbols known to mankind, if drawn on ISF 200 in a standard fashion. However, as the invention is customizable, this means that the user can alter or augment the corresponding database. Alter is defined to mean that the user changes the trace in an association so that one trace relates to one symbol. Augment is defined to mean that a user can relate several traces to one symbol. For example a trace similar to “A” or “a” could always be made to just output “A” to the corresponding device.

It can be seen that associations provide complex and dynamic relationships between traces and symbols, where users can relate many traces to a single symbol and a trace or numerous traces can result in the output of the same group of at least one symbol.

As shown in FIG. 3, an illustration of some of the points which are interspersed with the keypad of a corresponding mobile phone is depicted.

FIG. 3 is first viewed as a mechanical layout of sensors around keypad digit 160 for the “switched” embodiment, and then secondly viewed as a layout of X/Y points on a touchpad utilized by the “tablet” embodiment.

Firstly, considering the “switched” embodiment; the points 600, 610, 620, 630 and 640 represent micro-switches present in the input surface which is integrated with the corresponding device, exemplified as a mobile phone.

Secondly considering the “tablet” embodiment; the points 600, 610, 620, 630 and 640 represent X/Y locations on a touchpad forming the input surface which is integrated with the corresponding device, exemplified as a mobile phone. Zone 130 represents the normal surface of the touchpad, into which key 160 has been integrated. Zone 130 feels and reacts the same as a traditional touchpad. The corresponding controlling software, which monitors inputs on zone 130, recognizes only those locations indicated by points 600, 610 and the like. Therefore, what was previously a virtually infinite collection of X/Y input coordinates, has been reduced to a substantially lower number of X/Y coordinates.

For clarity, FIG. 3 is used to explain both the “switched” and “tablet” embodiments.

As shown in FIG. 3, the relationship of the interconnected points and how they are monitored is provided. Software methods that are well known in the art are used to monitor key switches and the order in which they are depressed. Likewise, monitoring the X/Y location of a mouse, input stylus and the like are also implemented using software that is well known in the prior art.

The practice of pattern recognition is well known in the prior art. To exemplify how patterns can be formed from traces the following guide is offered. A line L1 is formed by the connection of point 600 to point 610. A line L2 is formed by the connection of point 610 to point 640. A line L3 is formed by the connection of point 600 to point 640. A trace entered as the triggering of points, in the order of point 600, point 610, point 640 and ending at the start-point 600 would therefore from lines L1, L2 and L3, in that specific order. Normalization, as defined earlier, allows for the pattern “L1 L2L3” to be recognized as being the same pattern as “L2L3L1”. Regardless of the pattern, or order, in which L1, L2 and L3 occur, a triangle is formed, being a single trace. The triangle can then be associated with an action having meaning to the corresponding device. Where the input apparatus recognizes the pattern of “L1 L2L3”, or its normalized siblings, the associated symbol or command is emitted to the corresponding device.

Points 620 and 630 offer a higher “resolution”, or in other words, a wider variety of trace paths. Points 620 and 630 are optional, as a direct connection can be made between points 600 and 640. However, if points 620 and 630 are present together with similar points close to key 160, then traces more akin to naturally drawn letters can be formed, which may be more aesthetically pleasing to the user.

A further step may be required, which one of ordinary skill might refer to as “data reduction”, when points 620 and 630 or similar, are present. If points 600, 620, 630 and 640 were connected by a single line drawn by the user, then an identical line to L3 will have been drawn. Therefore the pattern of points 600, 620, 630 and 640, defined as L4, could easily be reduced to a pattern of points being simply points 600 and 640. This reduces the size of the data required to represent L4, so it becomes identical, in size and point data content, to L3.

Data reduction can also be used as a further means of normalization. To illustrate, no matter how long a line is, or where it occurs on the input apparatus, it can be taken to be a line, or in effect a vector, having a given orientation and direction. Therefore, line L5, being point 600 connected to point 620, and L6, being points 600 and 640 and L7, being points 630 and 640 all form diagonal lines of varying length and position moving from top left to bottom right, in effect forming the trace of a backslash. This illustration shows the wide ranging applications of normalization and how input patterns can be desensitized as to their location. A backslash occurring anywhere on the input apparatus is still a backslash, as is any other trace, which can be drawn in multiple locations.

Geometrical speaking, when a shape is moved from one location to another, in an X/Y coordinate space, it is said the shape is transformed. Therefore, transformation can be seen as a means of additional normalization, in that traces are all moved, or transformed, as far to the top left corner of the X/Y coordinate space, formed by the points, as is possible. Therefore, if points 630 and 640 were connected by the user, then the resulting trace were transformed to the top left of the coordinate space, then it would have been the same input as points 600 and 620 being connected, again forming the backslash character.

The programming languages of VISUAL BASIC, C++ and JAVA are all ideally suited to the development of embedded systems. The corresponding software for the input apparatus is an embedded system, which is concerned with the monitoring and recognition of inputs followed by the emission of associated symbols and commands.

The invention can now be viewed as being a device with finite inputs, but with apparently infinite applications and matching outputs, formed by the amalgamation of a hardware component, being an input surface, and a software component concerned with the monitoring of the inputs occurring via the hardware component.

By coupling the invention with the appropriate buffer technology, used to connect the invention to the corresponding device, for example an RS232, USB or optical interface, all well known in the art, a multitude of possibilities exist to have the invention act as the user interface to any industrial or domestic device.

Many well known VLSI devices are available containing an integration of processor and random access memory, together with basic I/O capabilities, programmable read only memory and the like, all of which are required for computational and storage requirements of the input apparatus.

The database can be pre-loaded with information, which may increase the convenience of use of the input apparatus, in that, by supplying a preloaded set of traces associated with individual alphanumeric symbols. Thus, the user will have a preset character set that can be used for textual and numerical input.

For convenience, the user can have the invention ignore invalid traces, where invalid trace is defined as a trace having no matching patterns in the corresponding database, or, can opt for the invention to offer a table of known symbols which may be associated with the current trace. Furthermore, those symbols which are already associated with traces can be omitted from the table offered, to reduce the number of symbols from which the user would have to select.

In order to create a symbol which has not previously been known to the invention the user can opt to have a symbol, identical in shape and size of the current trace, entered into the corresponding database. An association can then be formed automatically between the trace of the previously unknown symbol and its trace input counterpart. Alternatively, the user can associate another trace with the new symbol.

By incorporating wireless network technology, such as BLUETOOTH, it is recognized that users can exchange information from their input apparatus with each other. Further use of wireless technology permits the input apparatus to interact with any number of corresponding devices, which are similarly equipped with wireless technologies.

A further method of input exists whereby the individual points are simply tapped by implement 210, which is lifted and applied to the input surface in between each point being visited. This means that there is not a continuous physical pressure applied to the input surface by implement 210, as is preferred by the invention. Instead, the deployment of a timeout, defined as a time which elapses between the activation of individual points, is required. A timeout period, for example of one second, begins to countdown after each point is activated. If another point is activated within one second of the previous point being activated, then the point is added to the current trace in order to form the next line in the trace. If the timeout period expires then the current trace is deemed to be complete, i.e. has no further lines to be input, then the search for a matching trace in the database can be executed. The tapping method is less convenient, as smooth movement between points, without lifting implement 210 is so much faster. However, it may be necessary, due to some physical condition of the user, or the requirements of the corresponding device, that the tapping method be employed. It is recognized that the tapping method will have a slower rate of character input than drawing, in the traditional sense, upon the input surface.

The preferred method of the invention is to end a trace when implement 210 is lifted from the input surface, as this provides near normal handwriting speed of input to occur. Further, by utilizing a recognized shorthand system, or by creating a new one, the user can reach substantial input speeds.

The aforementioned tapping method can have one distinct advantage over the drawing trace method of input. If a symbol were assigned to each unique point on the input surface then the user will have the ability to type, with what is effectively a touch sensitive keyboard. Using the “tablet” embodiment a wider variety of X/Y locations is available to be defined as points, and therefore as locations for the activation of symbols. The “switched” embodiment is recognized as having a much lower number of available points, and therefore fewer symbol assignments to the input surface may be made.

At all times, whether the tapping method or trace drawing method is used, all methods can be made available simultaneously, as they are not mutually exclusive. For example, the user can first dial a number by pressing the digit keys on the keypad, then enter a trace instructing the mobile phone to enter SMS message mode, then employ the tapping method to enter the characters of the text message itself.

A multi-mode input device is therefore demonstrated by the availability of differing input methods, utilizing the same hardware user interface. It is therefore not necessary to alter manufacturing processes or components of the input apparatus to make the several modes available. All that need be done is to make provision, within the corresponding software, for recognition of input by tap or drawing, upon the input surface.

A further mapping of input surface activity can be made if, for example, points on the input surface are connected to the triggering of command buttons within a software application executing on the corresponding device. For example, point 600 can be tapped for OK and point 610 can be tapped for CANCEL, where OK and CANCEL are two exemplary command buttons which might be displayed by a software application.

The illustrated embodiments of the invention are intended to be illustrative only, recognizing that persons having ordinary skill in the art may construct different forms of the invention that fully fall within the scope of the subject matter disclosed herein.

What is claimed is:

1. An input apparatus which serves as an input interface for other electronic devices comprising:
an input surface comprising:
a plurality of pressure sensitive sensors which area adapted to track the movement of an implement which comes exerts pressure on said input surface;
such that pressure exerted on said input surface by a user using the implement activates at least one of said sensors which provides at least one line thus defining a trace path;
a memory having a database which serves to store said trace path;
association means for associating said trace path with a symbol that is known to the user thus providing an association;
output means for transmitting said symbol to said input apparatus.

2. The input apparatus of claim 1 wherein said input surface further comprises a series of interconnected channels which serves to guide said implement along said sensors.

3. The input apparatus of claim 2 wherein the implement is a stylus.

4. The input apparatus of claim 2 wherein the implement is the finger of the user.

5. The input apparatus of claim 2 wherein the most recent trace path is at least partially illuminated.

6. The input apparatus of claim 5 wherein the symbol which said trace path is associated corresponds to a glyph selected from the group consisting of characters of any language, numerical characters, mathematical symbols and other symbol well known to the user.

7. The input apparatus of claim 5 wherein the symbol which trace path is associated corresponds to at least one command that activates a device that is connected to said output means of said input apparatus.

8. The input apparatus of claim 7 wherein said device is a computer.

9. The input apparatus of claim 8 wherein said device is a mobile telephone.

10. The input apparatus of claim 1 wherein said sensors of said input surface is a plurality of micro-switches.

11. The input apparatus of claim 1 wherein said input surface is a touchpad.

12. The input apparatus of claim 10 wherein said input surface is integrated in the traditional keypad of a telecommunication device.

13. The input apparatus of claim 12 wherein the micro-switches and keys of the phone keypad lay virtually flat and wherein the micro-switches are activated by substantially less pressure being place thereon than the pressure required to activate said keys such that a trace path can be obtained without activating any of said keys.

14. The input apparatus of claim 6 wherein said trace path that is associated with a glyph does not have to bear any resemblance to character that is customarily associated with the shape of said trace path, thus the “O” shaped trace path can be associated with the “I” character.

15. The input apparatus of claim 1 wherein said trace path is associated with a plurality of multiple symbols.

16. The input apparatus of claim 1 further comprising biometric data capture means for measuring the speed and pressure of said trace path which provides a speed and pressure set which is stored in said memory as said trace path is being implemented onto said input surface wherein the user can be identified by the relatively unique speed and pressure dataset.
